(19) United States
(12) Patent Application Publication
(10) Pub. No.: US 2023/0007347 A1
(43) Pub. Date: Jan. 5, 2023

(54) VIDEO CONTENT ADAPTATION

(71) Applicant: CITRIX SYSTEMS, INC., Fort Lauderdale, FL (US)

(72) Inventors: DIVYANSH DEORA, Jaipur (IN); Arnav Akhoury, Jamshedpur (IN); Satish Vanahalli, Bangalore (IN); Nandikotkur Achyuth, Hyderabad (IN)

(21) Appl. No.: 17/363,351

(22) Filed: Jun. 30, 2021

(51) Int. Cl. H04N 21/454; G11B 27/036; G11B 27/34; H04N 21/8547

(52) U.S. Cl. CPC H04N 21/4542; G11B 27/036; G11B 27/34; H04N 21/8547

(57) ABSTRACT

A method, a system, and a computer program product for adapting video content to mitigate adverse health effects in users. A data file uploaded to a first storage location is detected. The data file is tagged upon determining a presence of one or more triggering content. At least one of a location and a type of the triggering content in the data file are determined. One or more timestamps identifying the location of the triggering content are inserted in the data file. A modified data file is generated and a playback of the modified data file is executed.

### BACKGROUND

A substantial percentage of population suffers from photosensitive epilepsy. This is a condition where an individual upon viewing certain types of images, videos, etc. may experience an epileptic seizure, which may result in death. While photosensitive epilepsy condition has been studied, content creators typically create video content without accounting for users suffering from this medical condition.

### SUMMARY

In some implementations, the current subject matter relates to a computer implemented method for adapting video content to mitigate adverse health effects in users. The method may include detecting a data file being uploaded to a first storage location and tagging the data file upon determining a presence of one or more triggering content, determining at least one of a location and a type of the triggering content in the data file, inserting, in the data file, one or more timestamps identifying the location of the triggering content, and generating a modified data file, and executing a playback of the modified data file.

In some implementations, the current subject matter can include one or more of the following optional features. The data file may include at least one of the following: a video data file, an image data file, a graphics data file, and any combination thereof. The triggering content may be a content configured to cause an adverse health reaction (e.g., an epileptic seizure) in a user upon the user viewing the content.

In some implementations, the first storage location may include at least one of the following: a database, a cloud storage location, a memory, a file system, a file sharing platform, a streaming system platform, a streaming system device, and any combination thereof.

The timestamps may include a first timestamp identifying a beginning of a playback of the triggering content in the data file and a second timestamp identifying an end of the playback of the triggering content in the data file. Insertion of timestamps may also include positioning an overlay image blocking a view of the triggering content during playback of the data file. The overlay image may be positioned between the first timestamp and the second timestamp.

In some implementations, the type of the triggering content may include at least one of the following: a luminance flash, a red flash, a high-contrast pattern, a repeated pattern, a high-contrast and repeated pattern, a color pattern, and any combination thereof.

The modified data file may be stored in a second storage location.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a system for performing data file content mitigation, according to some implementations of the current subject matter;

FIG. 2 illustrates an example of a process for analyzing a data file uploaded/downloaded/stored in a storage location for presence of a triggering content, according to some implementations of the current subject matter;

FIG. 3 illustrates examples of patterns that may trigger an adverse reaction in a user;

FIG. 4 illustrates an example of a non-triggering overlay image, according to some implementations of the current subject matter;

FIG. 5 illustrates an example of a blocking overlay, according to some implementations of the current subject matter;

FIG. 6 illustrates an example of a network environment, according to some implementations of the current subject matter;

FIG. 7 depicts a block diagram illustrating an example of a computing device, according to some implementations of the current subject matter;

FIG. 8 illustrates a high-level architecture of an example of a virtualization system for implementing the computing system shown in FIG. 1, according to some implementations of the current subject matter;

FIG. 9 illustrates an example of a method, according to some implementations of the current subject matter.

### DETAILED DESCRIPTION

To address the deficiencies of currently available solutions, one or more implementations of the current subject matter provide for an ability to adapt video content to mitigate photosensitivity issues in some users.

One in four thousand people in the world suffer from photosensitive epilepsy. A real concern for them is to not be accidentally exposed to a video content that can trigger an epileptic seizure. A video, graphical, etc. data files containing such triggering content may induce a violent seizure that can potentially be fatal. While photosensitive epilepsy is a known condition, few existing content creators actively ensure that their video, graphical, etc. content would not cause it to occur, or provide users with control over the content being served to them.

In some implementations, the current subject matter may be configured to analyze a data file, e.g., a video, a graphical data file, etc., that may cause an adverse health reaction (e.g., a seizure, epilepsy, etc.) of a user. The data file may be received (e.g., uploaded, downloaded, etc.) and stored in a storage location (e.g., a database, a cloud storage location, a memory, a file system, a file sharing platform, a streaming system platform and/or device, etc.). The analysis of the data file may include checking the data file for presence of a triggering content. The triggering content may include one or more video, graphical, audio, etc. patterns, frequencies, and/or intensity. Non-limiting examples of such content may include at least one of the following: a luminance flash, a red flash, a high-contrast pattern, a repeated pattern, a high-contrast and repeated pattern, a color pattern, and/or any other triggering content and any combination thereof. The triggering content may be present in one or more portions of the data file, and/or the entire data file. For example, a 15-second long video file may include a high-contrast and repeated pattern of images between 4^{th} and 8^{th} seconds of the video. Upon detecting the triggering content, the current subject matter may be configured to tag the video file and insert one or more timestamps corresponding to the beginning and end of the location of the data file that has this content. Moreover, the triggering content may be blocked from view (e.g., by a blank screen, a warning, etc.), playback of the data file may be paused immediately prior to (e.g., corresponding to the first inserted timestamp) the displaying of the triggering content so that the user is not automatically exposed to the triggering content. The user may be presented with an option to skip the triggering content, in which case, the playback of the data file may resume after the second timestamp (corresponding to the end of the triggering content). Alternatively, or in addition to, the user may choose to view the triggering content. The user may also be presented with any other actions (e.g., deletion of the data file, modification of the data file, removal of the triggering content, addition of further warnings, etc.).

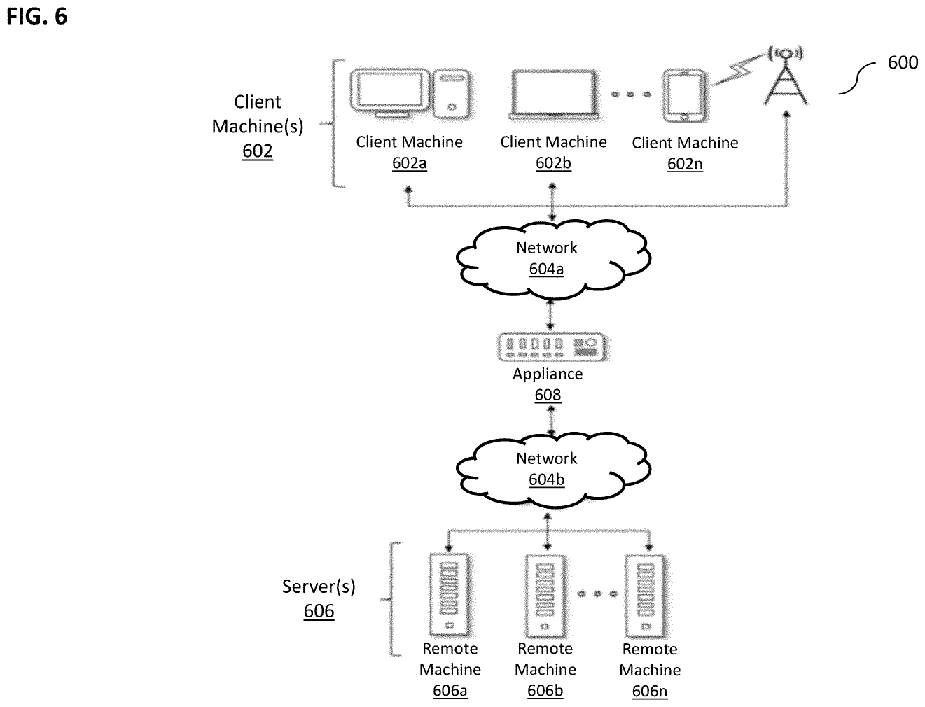

In some implementations, the current subject matter system may be implemented in a scalable and extendable architecture (such as the one shown in FIGS. 6-8) that may be configured to execute various processes (e.g., anti-virus, search, etc.) in its storage location on files that may be stored therein (e.g., uploaded, downloaded, transmitted to, etc.). In some example implementations, the current subject matter system may be configured to be implemented as a plug-in for such architecture that may be configured to identify potentially problematic data files (e.g., video content, graphical content, etc.), mark it as triggering, and use various techniques to prevent the user from being accidentally exposed to it.

As stated above, an analysis on the data file (e.g., video, graphical file, etc.) may include checking the data file for one or more patterns/frequency/intensity/etc. that may trigger a reaction in a user. For example, the checking may include identifying whether luminance flash, red flash, and high-contrast-repeated-pattern based content is present in a video.

In some implementations, in order to detect whether a data file includes a triggering content, the current subject matter system may be configured to determine whether the data file includes at least one of the following: a high contrast, high luminance flashing image(s, high contrast, repeated-pattern visuals, and/or any combination thereof. To determine whether the data file includes high contrast, high luminance flashing image(s), the current subject matter system may be configured to detect at least one of the following parameters: flash frequency, flash intensity, flash area, color, and any combination thereof.

To detect flash frequency, the current subject matter system may be configured to determine whether a video flash and/or a flicker occurs in the data file when there is a pair of opposing changes in the video luminance, e.g., an increase of luminance followed by a decrease in luminance, and/or a decrease in luminance followed by an increase in luminance. For example, while a small percentage of users may experience adverse health effects in response to a flash with frequency below 3 Hz, a larger percentage of users may experience adverse health effects when the flash frequency is greater than 3 Hz and less than 16 Hz or greater than 60 Hz.

Flash intensity may refer to a luminance of a display that the user may be using to view the data file, and the contrast between the increased and decreased states. For example, a contrast of more than 20% may be potentially be seizure inducing, and a contrast of 60% or more may likely induce symptoms in all users.

Flash area may be a surface area of a part of an image that may trigger a reaction in a user. This may range from 9% of users if 1/10^{th} of a screen carries the screen luminance variation, all the way up to 100% if the full screen is flashing.

Color of the light emitted (or emanating from the screen showing the triggering image) may also be important. For example, a red light between 660 nm to 720 nm of the same luminosity as blue and/or white light may induce seizures.

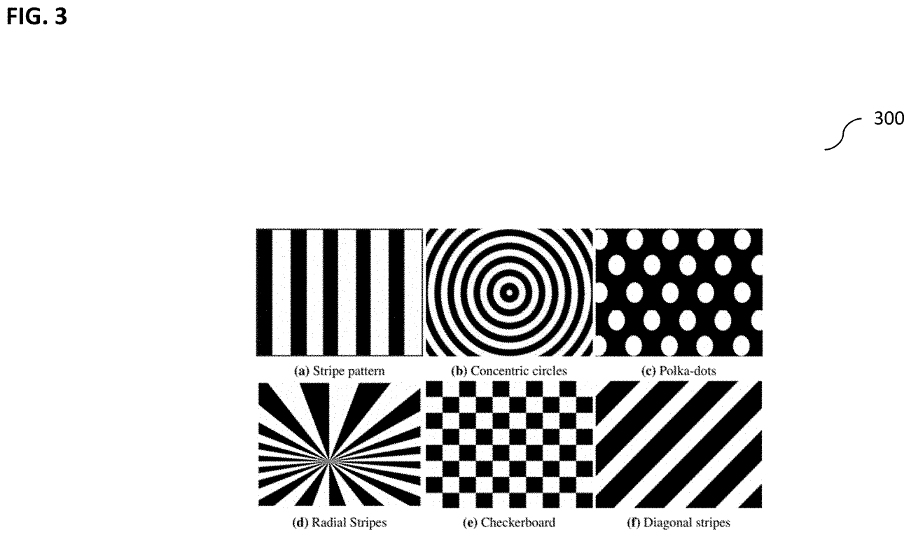

Further, the current subject matter system may be configured to check the data file for presence of high contrast and/or repeated-pattern visuals. Up to 30% of users may be sensitive not just to flicker but also geometric patterns. In this case, the current subject matter system may be configured to consider a type of pattern that may trigger a reaction in a user. FIG. 3 illustrates examples of patterns 300 that may trigger an adverse reaction in a user. As shown in FIG. 3, the patterns may include a stripe pattern, a concentric circles pattern, a polka-dots pattern, a radial stripes pattern, a checkerboard pattern, a diagonal stripes pattern, and/or any other type of pattern. Additionally, one or more of the following factors may be assessed by the current subject matter system: a spatial frequency (i.e., how often the pattern repeats in the field of vision), a size of a pattern, pattern luminance (e.g., brightness), contrast, and/or any combination thereof. Moreover, any potentially harmful regular pattern that contains clearly discernible stripes when there are more than five light-dark pairs of stripes in any orientation may be determined as being triggering. The stripes may be parallel and/or radial, curved and/or straight, and may be formed by rows of repetitive elements such as polka dots. The system may determine that if the stripes change direction, oscillate, flash and/or reverse in contrast, they may be more likely to be harmful than if they are stationary.

In some implementations, the current subject matter system may implement various existing software tools to perform frame-by-frame analysis to capture luminosity, color, pattern, area, etc. in order to gauge whether a content (e.g., video, image, graphics, etc.) of the data file would not trigger an adverse reaction in a user and would be within safe limits. The safe limits may be defined as follows. There are no more than three general flashes and no more than three red flashes within any one-second period. Alternatively, or in addition to, the combined area of flashes occurring concurrently may occupy, for example, no more than a total of one quarter of any 341×256-pixel rectangle anywhere on the displayed screen area when the content is viewed at 1024 by 768 pixels.

In some implementations, the current subject matter may be configured to perform analysis of the data files that have been uploaded/downloaded and/or stored in a storage location (e.g., a database, a cloud storage location, a memory, a file system, a file sharing platform, a streaming system platform and/or device, etc.), determine whether the data file (e.g., contain harmful content that may trigger a reaction in a user) may be harmful to a user, tag the data file as potentially harmful, insert one or more timestamps indicative of a location of the harmful content, and insert an element that may prevent the user from being accidentally exposed to the harmful content. The above process may be performed automatically upon detecting that a data file has been uploaded to the storage location. Alternatively, or in addition to, it may be performed and/or reviewed by an administrator. This process may provide users with an ability to skip harmful content rather than not view the entire video and/or offer users an overlay that may significantly diminish the risk of a harmful health reaction (e.g., seizure, etc.) by reducing the contrast (and/or any other factors) to within the safe limits.

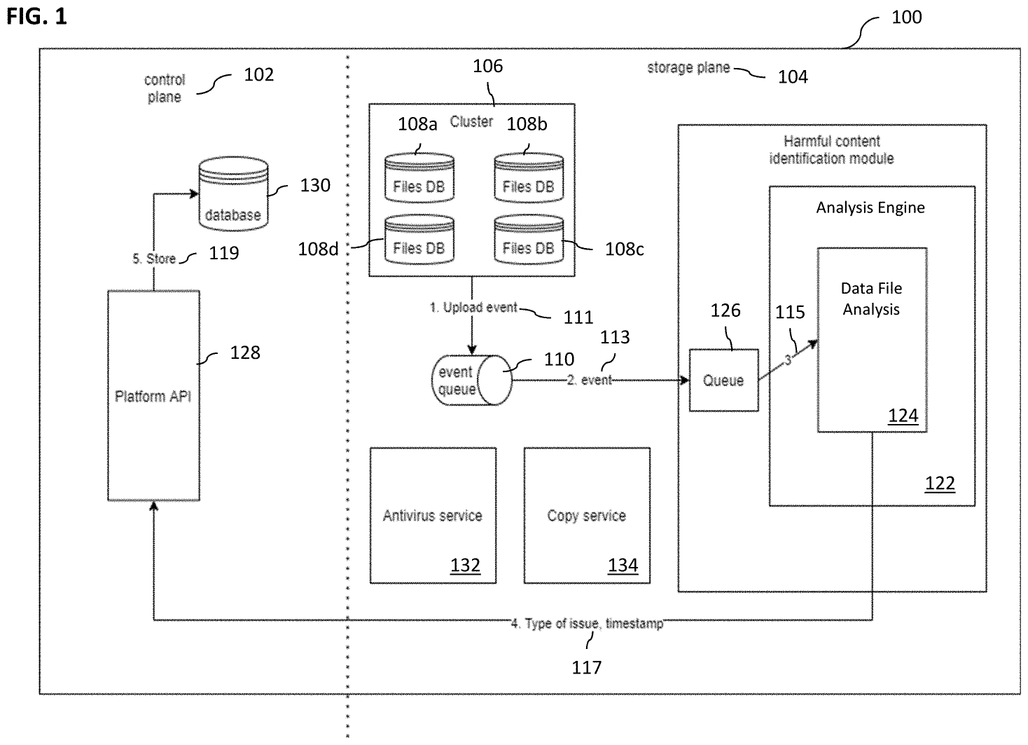

FIG. 1 illustrates an example of a system 100 for performing data file content mitigation, according to some implementations of the current subject matter. As stated above, a data file may include a video file, an image file, a graphics file, and/or any other data file. Content mitigation may be configured to reduce and/or prevent an adverse health reaction in a user viewing the data file and/or portion thereof that may contain content that may be deemed harmful to the user. The system 100 may be configured to be implemented in one or more database, a cloud storage location, a memory, a file system, a file sharing platform, a streaming system platform and/or device, and/or in any other platform, device, system, etc., and/or any combination thereof. One or more components of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The components of the system 100 may include any combination of hardware and/or software. In some implementations, such components may be disposed on one or more computing devices, such as, server(s), database(s), personal computer(s), laptop(s), cellular telephone(s), smartphone(s), tablet computer(s), and/or any other computing devices and/or any combination thereof. In some implementations, these components may be disposed on a single computing device and/or can be part of a single communications network. Alternatively, or in addition to, the components may be separately located from one another.

Referring back to FIG. 1, the system 100 may be configured to include a control plane 102 and a storage plane 104. The control plane 102 may include one or more application programming interfaces (e.g., video platform API) 128 and a database and/or any other storage location 130 that may be configured to store data files that may have been processed by one or more components of the storage plane 104.

The storage plane 104 may be configured to include a storage cluster 106 and a harmful (or triggering) content identification module 120. Additionally, the storage plane 104 may be configured to include on or more optional computing components, e.g., antivirus service module 132, a copy service module 134, and/or any other modules that may be responsible for processing of data files (e.g., checking for viruses, copying files, etc.) that may be uploaded to the system 100.

The storage cluster 106 may be configured to include one or more file databases and/or storage locations 108 (a, b, c, d). The file databases 108 may be configured for storage of one or more data files that may be analyzed by the module 120 for any triggering content that may be harmful to a user. The harmful (or triggering) content identification module 120 may include an analysis engine 122 that may include data file analysis module 124 (e.g., that may analyze files for presence of content that may trigger a photosensitive epilepsy, and/or any other adverse health reaction in a user).

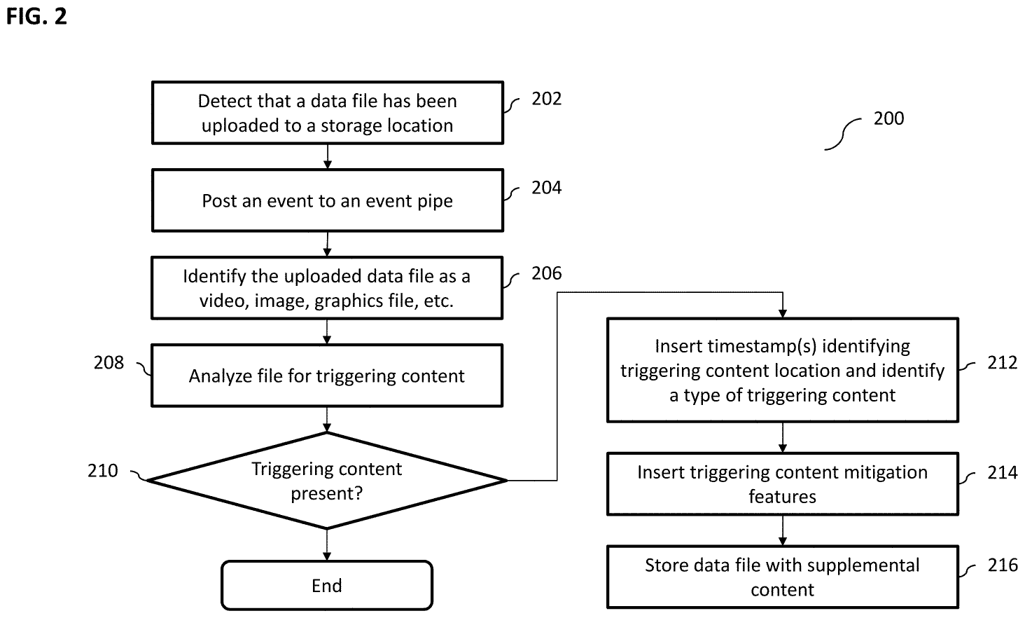

FIG. 2 illustrates an example of a process 200 for analyzing a data file uploaded/downloaded/stored (“uploaded”) in a storage location for presence of a triggering content, according to some implementations of the current subject matter. The process 200 may be performed by the system 100 shown in FIG. 1. Referring to FIGS. 1-2, at 202, the system 100 may be configured to detect that a data file (e.g., a video file, an image file, a graphics file, etc.) may have been uploaded to a storage location, e.g., one of the file databases 108 in the cluster 106 of the storage plane component 104.

Once the data file has been uploaded to one of the databases 108, an event 111 may be uploaded/posted to an event queue/pipe 110, at 204. Once such event has been posted, all services that may be listening to postings of events in the event pipe 110, may process this event. The services in the storage plane 104 that may be listening include at least one of the following: the antivirus service 132, the copy service 134, the analysis engine 120, and/or any other services and/or any combinations thereof.

As stated above, the analysis engine 120 may be configured to read the posted event 113 from the event pipe 110. As part of reading the event, the analysis engine 120 may also identify the uploaded data file as a video file, an image file, a graphics file, and/or any other data file that may include various video/image/graphical/etc. content. The analysis engine 120 may also place the data file in a queue 126 that may include a list of data files that the analysis engine 120 may need to analyze for potentially triggering content.

At 208, the data file analysis component 124 of the analysis engine 120 may be configured to process the data file for the purposes of identifying any triggering content. As stated above, a triggering content may be content that may trigger an adverse reaction in a user viewing the data file on a computing device and/or any other device with viewing capabilities (e.g., a display monitor, a display of a smartphone, a tablet, a laptop, a movie screen, etc.). The triggering content may include pattern(s), frequency(ies), color(s), intensity(ies) that may be harmful to the user (e.g., a user with a photosensitive epilepsy health condition, etc.). The data file analysis component 124 may be configured to determine whether a triggering content exists, location of the triggering content in the data file (e.g., at 10 seconds after beginning of the video), duration of the triggering content, and a type of triggering content.

If, at 210, the data file analysis component 124 determines that no triggering content exists, the process 200 may be configured to terminate. Otherwise, triggering content is found in the data file, the data file analysis component 124 may be configured to insert one or more timestamps into the data file, e.g., a first or a start timestamp at the beginning of the triggering content and a second or an end timestamp at the end of the triggering content, at 212. In addition to insertion of timestamps, the data file analysis component 124 may also insert various metadata and/or other data that may identify a type of triggering content (e.g., pattern(s), frequency(ies), color(s), intensity(ies), etc.).

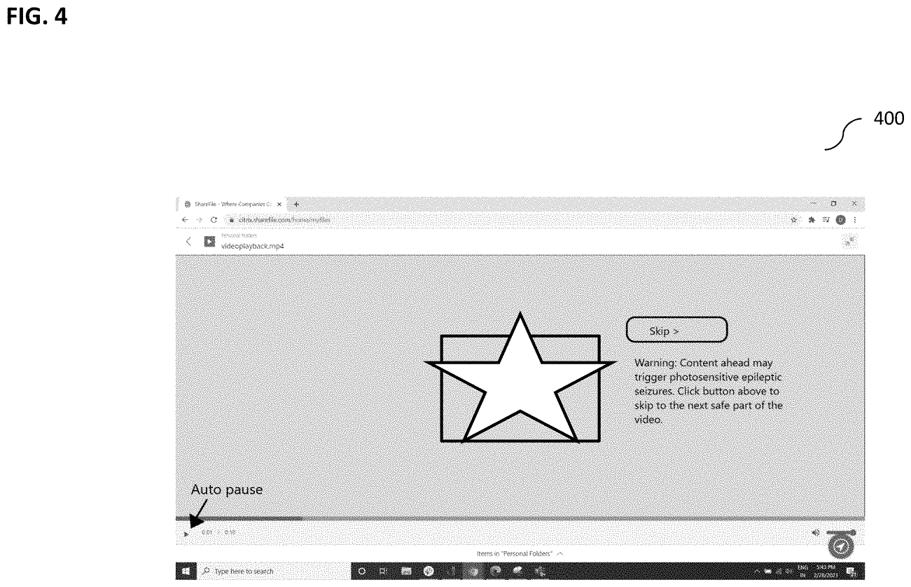

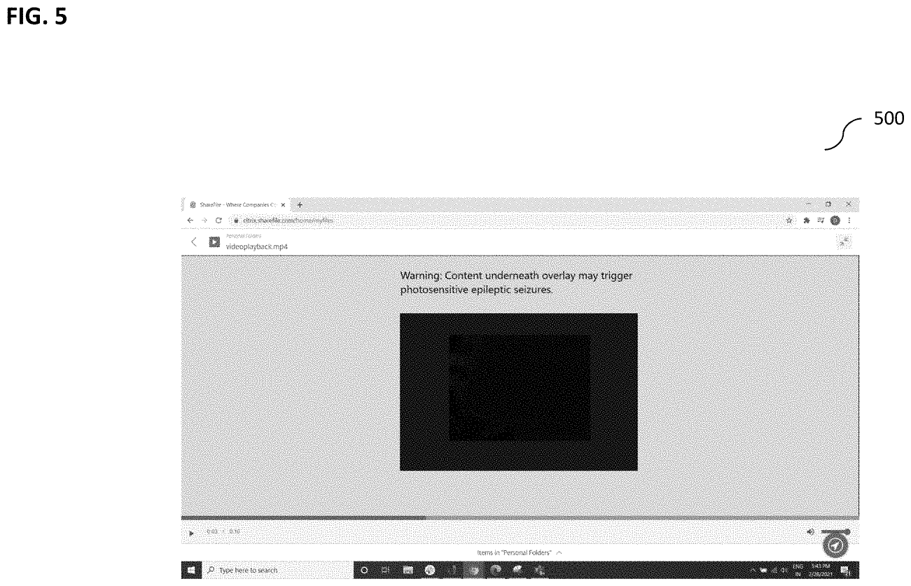

The data file analysis component 124 may also insert one or more triggering content mitigation features and/or elements, at 224. The mitigation features and/or elements may include a blocking screen (e.g., a non-triggering image 400 (as shown in FIG. 4), a dark color rectangle 500 (as shown in FIG. 5), etc.), an overlay screen, etc. that may prevent the user from viewing the triggering content during the entire duration of the triggering content. Alternatively, or in addition to, the data file analysis component 124 may also insert a warning to the user that triggering content is present in the data file and/or indicate duration of the triggering content, type of triggering content, etc.

Moreover, the data file analysis component 124 may package the data file, timestamps, metadata, and/or any other data that the data file analysis component may have inserted and generate a consumable data file (e.g., JavaScript Object Notation (JSON) file, etc.). The packaged data file 117 may be supplied to the control plane 102's API 128, which in turn, may store the packaged data file 119 in a supplemental database 130, at 216.

When the packaged data file 119, e.g., a video, etc., is being consumed (e.g., viewed on a computer screen, etc.), and if metadata associated with the data file identifying it as a video with potential health concerns (e.g., seizure, epilepsy, etc.), the system 100 may be configured to generate a prompt to the user either at the beginning of the playback of the video data file and/or prior to the portion of the video data file where triggering content is found, and provide the user with, for example, a photosensitive epileptic seizure warning.

Often, video data files, for example, may include a triggering content in a small fraction of the playback time of the data file. Thus, the system 100 may be configured to allow the users to consume the rest of the data file, where the video data file may be paused (e.g., immediately prior to, 2 seconds prior to, etc.) before the first timestamp (as inserted by the data file analysis component 124) of the triggering content and generate, for example, an overlay that may warn the user of the risks that may be involved in viewing the triggering content. The system 100 may also allow the user to skip playback of the portion of the data file containing the triggering content. While the content is being skipped, an overlay may be generated on top of the triggering content for its duration. The overlay may nullify effects of the flash trigger by reducing contrast, while letting the user consume a modified version of the same content.

Moreover, when seeking a specific part of the video, the same tools, as discussed above, may be used to protect the user. In some example implementations, subtitles may be rendered on top of the overlay for convenience, either the ones that may be available, and/or via real-time subtitle generation.

The system 100 may also be configured to request the user to make a default selection for viewing future data files with triggering content. This way every time the user is viewing a video with a triggering content, the user is not interrupted to make a particular choice as to how the user may wish to avoid (or view) the triggering content.

FIG. 6 illustrates an example of a network environment 600, according to some implementations of the current subject matter. Referring to FIGS. 1-6, the network environment 600, in which various aspects of the disclosure may be implemented, may include one or more clients 602a-602n, one or more remote machines 606a-606n, one or more networks 604a and 604b, and one or more appliances 608 installed within the network environment 600. The clients 602a-602n communicate with the remote machines 606a-606n via the networks 604a and 604b.

In some example implementations, the clients 602a-602n may communicate with the remote machines 606a-606n via an appliance 608. The illustrated appliance 608 is positioned between the networks 604a and 604b, and may also be referred to as a network interface or gateway. In some example implementations, the appliance 608 may operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. In some example implementations, multiple appliances 608 may be used, and the appliance(s) 608 may be deployed as part of the network 604a and/or 604b.

The clients 602a-602n may be generally referred to as client machines, local machines, clients, client nodes, client computers, client devices, computing devices, endpoints, or endpoint nodes. One or more of the clients 602a-602n may implement, for example, the client device 130 and/or the like. The remote machines 606a-606n may be generally referred to as servers or a server farm. In some example implementations, a client 602 may have the capacity to function as both a client node seeking access to resources provided by a server 606 and as a server 606 providing access to hosted resources for other clients 602a-602n. The networks 604a and 604b may be generally referred to as a network 604. The network 604 including the networks 604a and 604b may be configured in any combination of wired and wireless networks.

The servers 606 may include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 606 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

In some example implementations, a server 606 may execute a remote presentation services program or other program that uses a thin-client or a remote-display protocol to capture display output generated by an application executing on a server 606 and transmit the application display output to a client 602.

In yet other example implementations, a server 606 may execute a virtual machine, such as the first virtual machine and/or the second virtual machine, to provide, for example, to the user at a client device, access to a computing environment such as the virtual desktop. The virtual machine may be managed by, for example, a hypervisor (e.g., a first hypervisor, a second hypervisor, and/or the like), a virtual machine manager (VMM), or any other hardware virtualization technique within the server 606.

In some example implementations, the network 604 may be a local-area network (LAN), a metropolitan area network (MAN), a wide area network (WAN), a primary public network, and/or a primary private network. Additional implementations may include one or more mobile telephone networks that use various protocols to communicate among mobile devices. For short-range communications within a wireless local-area network (WLAN), the protocols may include 802.11, Bluetooth, and Near Field Communication (NFC).

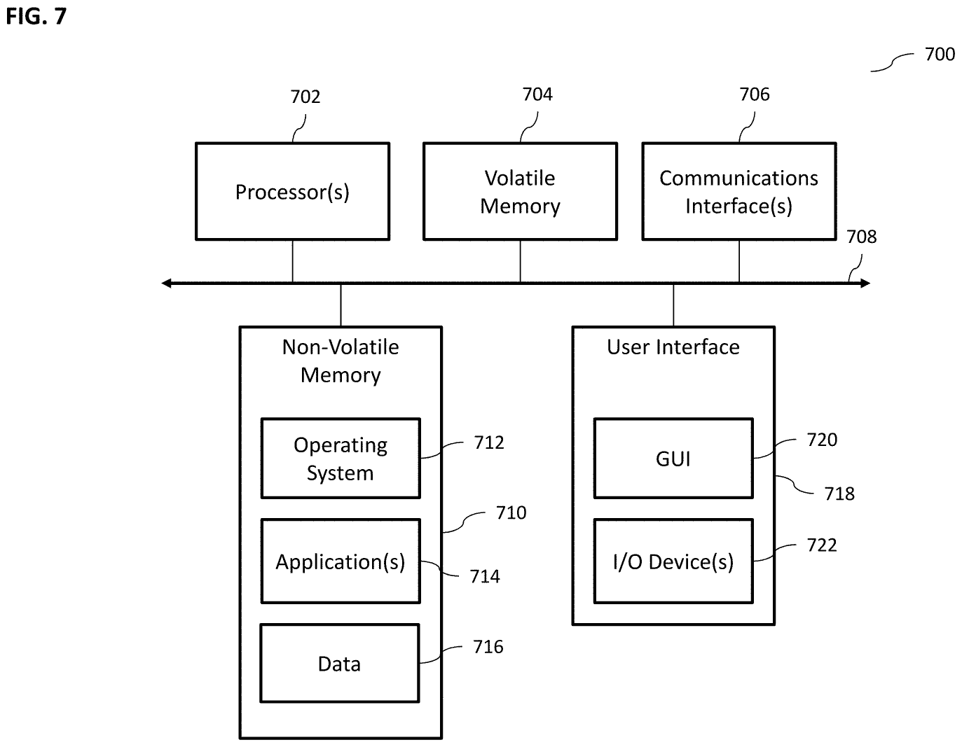

FIG. 7 depicts a block diagram illustrating an example of a computing device 700, in accordance with some example implementations. Referring to FIGS. 1-7, the computing device 700 may be useful for practicing an implementation of the system 100 and analysis engine 120.

As shown in FIG. 7, the computing device 700 may include one or more processors 702, volatile memory 704 (e.g., RAM), non-volatile memory 710 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 718, one or more communications interfaces 706, and a communication bus 708. The user interface 718 may include a graphical user interface (GUI) 720 (e.g., a touchscreen, a display, and/or the like) and one or more input/output (I/O) devices 722 (e.g., a mouse, a keyboard, and/or the like). The non-volatile memory 710 may store an operating system 712, one or more applications 714, and data 716 such that computer instructions of the operating system 712 and/or applications 714 are executed by the processor(s) 702 out of the volatile memory 704. Data may be entered using an input device of the GUI 720 or received from I/O device(s) 722. Various elements of the computing device 700 may communicate via communication the communication bus 708. The computing device 700 as shown in FIG. 7 is shown merely as an example, as the resource controller 150 and the client device 130 may be implemented by any computing or processing environment and with any type of machine or set of machines that may have suitable hardware and/or software capable of operating as described herein.

The processor(s) 702 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some example implementations, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some example implementations, the “processor” may be one or more physical processors or one or more “virtual” (e.g., remotely located or “cloud”) processors.

The communications interfaces 706 may include one or more interfaces to enable the computing device 700 to access a computer network such as a local area network (LAN), a wide area network (WAN), a public land mobile network (PLMN), and/or the Internet through a variety of wired and/or wireless or cellular connections.

As noted above, in some example implementations, one or more computing devices 700 may execute an application on behalf of a user of a client computing device (e.g., clients 602), may execute a virtual machine, which provides an execution session within which applications execute on behalf of a user or a client computing device (e.g., clients 602), such as a hosted desktop session (e.g., a virtual desktop), may execute a terminal services session to provide a hosted desktop environment, or may provide access to a computing environment including one or more of: one or more applications, one or more desktop applications, and one or more desktop sessions in which one or more applications may execute.

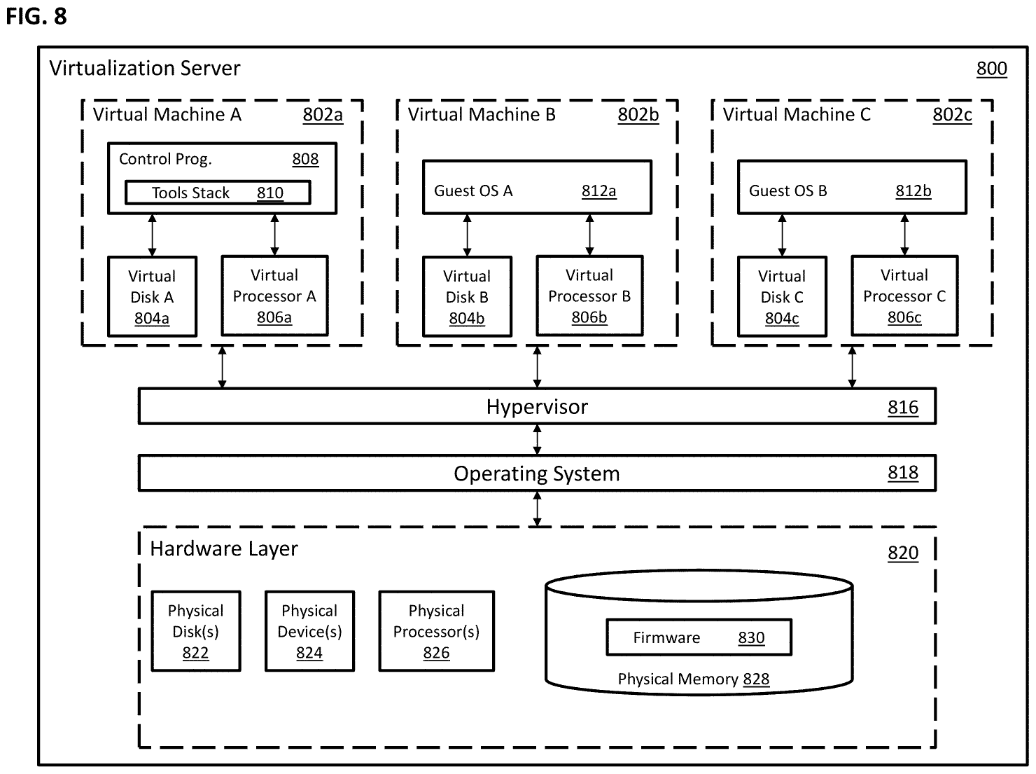

FIG. 8 illustrates a high-level architecture of an example of a virtualization system for implementing the computing system 100, in accordance with some example implementations. As shown in FIG. 8, the virtualization system may be a single-server or multi-server system, or a cloud system, including at least one virtualization server 800 configured to provide virtual desktops and/or virtual applications to one or more client access devices 602a-c. A desktop (or a virtual desktop) may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

Virtualization server 800 may be configured as a virtualization server in a virtualization environment, for example, a single-server, multi-server, or cloud computing environment. Virtualization server 800 illustrated in FIG. 8 may be deployed as and/or implemented by one or more implementations of server 606 illustrated in FIG. 6 or by other known computing devices. Included in virtualization server 800 is hardware layer 820 that may include one or more physical disks 822, one or more physical devices 824, one or more physical processors 826, and one or more physical memories 828. In some implementations, firmware 830 may be stored within a memory element in physical memory 828 and be executed by one or more of physical processors 826. Virtualization server 800 may further include operating system 818 that may be stored in a memory element in physical memory 828 and executed by one or more of physical processors 826. Still further, hypervisor 816 may be stored in a memory element in physical memory 828 and be executed by one or more of physical processors 826. Presence of operating system 818 may be optional.

Executing on one or more of physical processors 826 may be one or more virtual machines 802A-C (generally, 802). Each virtual machine 802 may have virtual disk 804A-C and virtual processor 806A-C. In some implementations, first virtual machine 802A may execute, using virtual processor 806A, control program 808 that includes tools stack 810. Control program 808 may be referred to as a control virtual machine, Domain 0, Dom0, or other virtual machine used for system administration and/or control. In some implementations, one or more virtual machines 802B-C may execute, using virtual processor 806B-C, guest operating system 812A-B (generally, 812).

Physical devices 824 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 800. Physical memory 828 in hardware layer 820 may include any type of memory. Physical memory 828 may store data, and in some implementations may store one or more programs, or set of executable instructions. FIG. 8 illustrates an implementation where firmware 830 is stored within physical memory 828 of virtualization server 800. Programs or executable instructions stored in physical memory 828 may be executed by the one or more processors 826 of virtualization server 800.

Virtualization server 800 may also include hypervisor 816. In some implementations, hypervisor 816 may be a program executed by processors 826 on virtualization server 800 to create and manage any number of virtual machines 802. Hypervisor 816 may be referred to as a virtual machine monitor, or platform virtualization software. In some implementations, hypervisor 816 may be any combination of executable instructions and hardware that monitors virtual machines 802 executing on a computing machine. Hypervisor 816 may be a Type 2 hypervisor, where the hypervisor executes within operating system 818 executing on virtualization server 800. Virtual machines may then execute at a layer above hypervisor 816. In some implementations, the Type 2 hypervisor may execute within the context of a user's operating system such that the Type 2 hypervisor interacts with the user's operating system. In other implementations, one or more virtualization servers 800 in a virtualization environment may instead include a Type 1 hypervisor (not shown). A Type 1 hypervisor may execute on virtualization server 800 by directly accessing the hardware and resources within hardware layer 820. That is, while Type 2 hypervisor 816 accesses system resources through host operating system 818, as shown, a Type 1 hypervisor may directly access all system resources without host operating system 818. A Type 1 hypervisor may execute directly on one or more physical processors 826 of virtualization server 800, and may include program data stored in physical memory 828.

Hypervisor 816, in some implementations, may provide virtual resources to guest operating systems 812 or control programs 808 executing on virtual machines 802 in any manner that simulates operating systems 812 or control programs 808 having direct access to system resources. System resources can include, but are not limited to, physical devices 824, physical disks 822, physical processors 826, physical memory 828, and any other component included in hardware layer 820 of virtualization server 800. Hypervisor 816 may be used to emulate virtual hardware, partition physical hardware, virtualize physical hardware, and/or execute virtual machines that provide access to computing environments. In still other implementations, hypervisor 816 may control processor scheduling and memory partitioning for virtual machine 802 executing on virtualization server 800. Examples of hypervisor 816 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 800 may execute hypervisor 816 that creates a virtual machine platform on which guest operating systems 812 may execute. When this is the case, virtualization server 800 may be referred to as a host server. An example of such a virtualization server is Citrix Hypervisor® provided by Citrix Systems, Inc., of Fort Lauderdale, Fla.

Hypervisor 816 may create one or more virtual machines 802B-C (generally, 802) in which guest operating systems 812 execute. In some implementations, hypervisor 816 may load a virtual machine image to create virtual machine 802. The virtual machine image may refer to a collection of data, states, instructions, etc. that make up an instance of a virtual machine. In other implementations, hypervisor 816 may execute guest operating system 812 within virtual machine 802. In still other implementations, virtual machine 802 may execute guest operating system 812.

In addition to creating virtual machines 802, hypervisor 816 may control the execution of at least one virtual machine 802. The hypervisor 816 may present at least one virtual machine 802 with an abstraction of at least one hardware resource provided by virtualization server 800 (e.g., any hardware resource available within hardware layer 820). In some implementations, hypervisor 816 may control the manner in which virtual machines 802 access physical processors 826 available in virtualization server 800. Controlling access to physical processors 826 may include determining whether virtual machine 802 should have access to processor 826, and how physical processor capabilities are presented to virtual machine 802.

As shown in FIG. 8, the virtualization server 800 may host or execute one or more virtual machines 802. Virtual machine 802 may be a set of executable instructions and/or user data that, when executed by processor 826, may imitate the operation of a physical computer such that virtual machine 802 can execute programs and processes much like a physical computing device. While FIG. 8 illustrates an implementation where virtualization server 800 hosts three virtual machines 802, in other implementations virtualization server 800 may host any number of virtual machines 802. Hypervisor 816 may provide each virtual machine 802 with a unique virtual view of the physical hardware, including memory 828, processor 826, and other system resources 822, 824 available to that virtual machine 802. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 816 may create one or more unsecure virtual machines 802 and one or more secure virtual machines 802. Unsecure virtual machines 802 may be prevented from accessing resources, hardware, memory locations, and programs that secure virtual machines 802 may be permitted to access. In other implementations, hypervisor 816 may provide each virtual machine 802 with a substantially similar virtual view of the physical hardware, memory, processor, and other system resources available to virtual machines 802.

Each virtual machine 802 may include virtual disk 804A-C (generally 804) and virtual processor 806A-C (generally 806.) Virtual disk 804 may be a virtualized view of one or more physical disks 822 of virtualization server 800, or a portion of one or more physical disks 822 of virtualization server 800. The virtualized view of physical disks 822 may be generated, provided, and managed by hypervisor 816. In some implementations, hypervisor 816 may provide each virtual machine 802 with a unique view of physical disks 822. These particular virtual disk 804 (included in each virtual machine 802) may be unique, when compared with other virtual disks 804.

Virtual processor 806 may be a virtualized view of one or more physical processors 826 of virtualization server 800. The virtualized view of physical processors 826 may be generated, provided, and managed by hypervisor 816. Virtual processor 806 may have substantially all of the same characteristics of at least one physical processor 826. Virtual processor 826 may provide a modified view of physical processors 826 such that at least some of the characteristics of virtual processor 806 are different from the characteristics of the corresponding physical processor 826.

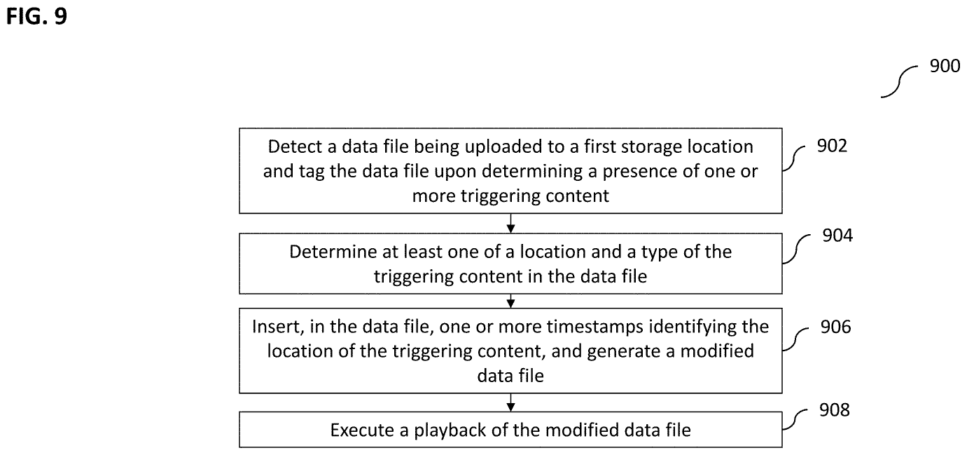

FIG. 9 illustrates an example of a method 900 for adapting video content to mitigate adverse health effects in users, according to some implementations of the current subject matter. The method 900 may be performed by the system 100 shown in FIG. 1. At 902, the system 100 (e.g., storage plane 104) may detect that a data file (e.g., a video, an image, etc.) is uploaded to a first storage location (e.g., one of the databases 108 in the database cluster 106). The system 100, and in particular the analysis engine 122 may be configured to analyze the data file for presence of a triggering content (e.g., content that may cause an adverse health effect (e.g., epileptic seizure) in a user if the user views such content) and tags the data file upon determining that such triggering content is present in the data file.

At 904, the analysis engine 122, and in particular, its data file analysis component 124, may determine at least one of a location (e.g., at a particular point in time during playback of the data file) and a type (e.g., patterns, specific intensity, specific color, etc.) of the triggering content in the data file.

At 906, the analysis engine 122, may be configured to insert, in the data file, one or more timestamps identifying the location of the triggering content. The engine 122 may also generate a modified data file, which may include, for example, the inserted timestamps, metadata (e.g., identifying type of the triggering content, etc.), and/or any mitigating features (e.g., an overlay, a warning, etc.). At 908, a playback of the modified data file may be executed. The modified data file may be stored in a second storage location (e.g., database 130 of the control plane 102).

In some implementations, the current subject matter can include one or more of the following optional features. The data file may include at least one of the following: a video data file, an image data file, a graphics data file, and any combination thereof. The triggering content may be a content configured to cause an adverse health reaction (e.g., an epileptic seizure) in a user upon the user viewing the content.

In some implementations, the first storage location (e.g., cluster 106) may include at least one of the following: a database, a cloud storage location, a memory, a file system, a file sharing platform, a streaming system platform, a streaming system device, and any combination thereof.

The timestamps may include a first timestamp identifying a beginning of a playback of the triggering content in the data file and a second timestamp identifying an end of the playback of the triggering content in the data file. Insertion of timestamps may also include positioning an overlay image blocking a view of the triggering content during playback of the data file. The overlay image may be positioned between the first timestamp and the second timestamp.

In some implementations, the type of the triggering content may include at least one of the following: a luminance flash, a red flash, a high-contrast pattern, a repeated pattern, a high-contrast and repeated pattern, a color pattern, and any combination thereof.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
detecting a data file being uploaded to a first storage location and tagging the data file upon determining a presence of one or more triggering content;
determining at least one of a location and a type of the triggering content in the data file;
inserting, in the data file, one or more timestamps identifying the location of the triggering content, and generating a modified data file; and
executing a playback of the modified data file.

2. The method according to claim 1, wherein the data file includes at least one of the following: a video data file, an image data file, a graphics data file, and any combination thereof.

3. The method according to claim 2, wherein the one or more triggering content is a content configured to cause an adverse health reaction in a user upon the user viewing the content.

4. The method according to claim 1, wherein the first storage location includes at least one of the following: a database, a cloud storage location, a memory, a file system, a file sharing platform, a streaming system platform, a streaming system device, and any combination thereof.

5. The method according to claim 1, wherein the one or more timestamps includes a first timestamp identifying a beginning of a playback of the one or more triggering content in the data file and a second timestamp identifying an end of the playback of the one or more triggering content in the data file.

6. The method according to claim 5, wherein the inserting includes positioning an overlay image blocking a view of the one or more triggering content during playback of the data file, the overlay image is positioned between the first timestamp and the second timestamp.

7. The method according to claim 1, wherein the type of the triggering content includes at least one of the following: a luminance flash, a red flash, a high-contrast pattern, a repeated pattern, a high-contrast and repeated pattern, a color pattern, and any combination thereof.

8. The method according to claim 1, wherein the modified data file is stored in a second storage location.

9. A system comprising:
at least one programmable processor; and
a non-transitory machine-readable medium storing instructions that, when executed by the at least one programmable processor, cause the at least one programmable processor to perform operations comprising:
detecting a data file being uploaded to a first storage location and tagging the data file upon determining a presence of one or more triggering content;
determining at least one of a location and a type of the triggering content in the data file;
inserting, in the data file, one or more timestamps identifying the location of the triggering content, and generating a modified data file; and
executing a playback of the modified data file.

10. The system according to claim 9, wherein the data file includes at least one of the following: a video data file, an image data file, a graphics data file, and any combination thereof.

11. The system according to claim 10, wherein the one or more triggering content is a content configured to cause an adverse health reaction in a user upon the user viewing the content.

12. The system according to claim 9, wherein the first storage location includes at least one of the following: a database, a cloud storage location, a memory, a file system, a file sharing platform, a streaming system platform, a streaming system device, and any combination thereof.

13. The system according to claim 9, wherein the one or more timestamps includes a first timestamp identifying a beginning of a playback of the one or more triggering content in the data file and a second timestamp identifying an end of the playback of the one or more triggering content in the data file.

14. The system according to claim 13, wherein the inserting includes positioning an overlay image blocking a view of the one or more triggering content during playback of the data file, the overlay image is positioned between the first timestamp and the second timestamp.

15. The system according to claim 9, wherein the type of the triggering content includes at least one of the following: a luminance flash, a red flash, a high-contrast pattern, a repeated pattern, a high-contrast and repeated pattern, a color pattern, and any combination thereof.

16. The system according to claim 9, wherein the modified data file is stored in a second storage location.

17. A computer program product comprising a non-transitory machine-readable medium storing instructions that, when executed by at least one programmable processor, cause the at least one programmable processor to perform operations comprising:
detecting a data file being uploaded to a first storage location and tagging the data file upon determining a presence of one or more triggering content;
determining at least one of a location and a type of the triggering content in the data file;
inserting, in the data file, one or more timestamps identifying the location of the triggering content, and generating a modified data file; and
executing a playback of the modified data file.

18. The computer program product according to claim 17, wherein the data file includes at least one of the following: a video data file, an image data file, a graphics data file, and any combination thereof, wherein the one or more triggering content is a content configured to cause an adverse health reaction in a user upon the user viewing the content.

19. The computer program product according to claim 17, wherein the first storage location includes at least one of the following: a database, a cloud storage location, a memory, a file system, a file sharing platform, a streaming system platform, a streaming system device, and any combination thereof.

20. The computer program product according to claim 17, wherein the one or more timestamps includes a first timestamp identifying a beginning of a playback of the one or more triggering content in the data file and a second timestamp identifying an end of the playback of the one or more triggering content in the data file;
wherein the inserting includes positioning an overlay image blocking a view of the one or more triggering content during playback of the data file, the overlay image is positioned between the first timestamp and the second timestamp;
wherein the type of the triggering content includes at least one of the following: a luminance flash, a red flash, a high-contrast pattern, a repeated pattern, a high-contrast and repeated pattern, a color pattern, and any combination thereof.
